(19) United States
(12) Patent Application Publication
(10) Pub. No.: US 2019/0205788 A1
(43) Pub. Date: Jul. 4, 2019

(54) METHOD OF USING DIGITAL CURRENCY FOR INCENTIVIZING DISTRIBUTED DISCOVERY OF NOVEL ALLOYS

(71) Applicants: David R. Hall, Provo, UT (US); Conrad Rosenbrock, Provo, UT (US); Benjamin Swenson, Lehi, UT (US); Jared Eggett, Lehi, UT (US); Matthew Van Dyke, Springville, UT (US); Raphael Pak, Orem, UT (US)

(72) Inventors: David R. Hall, Provo, UT (US); Conrad Rosenbrock, Provo, UT (US); Benjamin Swenson, Lehi, UT (US); Jared Eggett, Lehi, UT (US); Matthew Van Dyke, Springville, UT (US); Raphael Pak, Orem, UT (US)

(21) Appl. No.: 16/239,407

(22) Filed: Jan. 3, 2019

Related U.S. Application Data
(60) Provisional application No. 62/613,563, filed on Jan. 4, 2018.

(51) Int. Cl. G06N 20/00; G06Q 20/06; G06Q 40/06

(52) U.S. Cl. CPC G06N 20/00; G06Q 40/06; G06Q 20/065

(57) ABSTRACT

The method uses mass compute resources which are typically not in use to identify novel alloys. Owners of compute resources are offered a contract agreeing that the owner will receive a defined amount of a digital currency in exchange for the use of their compute resources. The digital currency may be managed using a blockchain ledger. The compute resources may be consumer devices which the user agrees to offer for use to develop alloys when the owner is not using the device. Academics and other entities may pay to select each group of elements to submit for computation. Profits realized by commercializing the alloys may be reinvested to fund the continued use of the method. The large amount of compute resources may be used to create a phase diagram for novel alloys in an amount of time that would otherwise be impossible.

### RELATED APPLICATIONS

This application claims the benefit of U.S. Provisional Patent Application No. 62/613,563 filed Jan. 4, 2018, which is hereby incorporated by reference in its entirety.

### BACKGROUND

### Field of the Invention

This disclosure relates to methods of discovering new materials and metal alloys.

### Background of the Invention

Many exciting technologies exist only as ideas because the materials needed to realize them do not exist. This is not because they cannot exist, but rather because we have not yet explored all the possible materials that may exist in our universe. In the past, several new materials have been discovered by alloying elements at specific compositions using an appropriate annealing schedule. However, these trial and error, by-hand approaches take excessive amounts of time and cannot practically investigate the full spectrum of material possibilities.

As an example, taking combinations of four different elements from the periodic table results in about 30 trillion materials that are likely to exist. Some of these will be interesting materials that may produce new and exciting technologies. Computational methods exist for predicting the properties of these materials, but they are also time consuming.

To fully investigate a single composition requires:
1. computation of its phase diagram, which encodes the stable structures that exist at a given temperature, pressure, and composition;
2. calculation of properties for each stable phase using full quantum-mechanical approximations; and
3. calculation of statistical properties using molecular dynamics simulations.

Calculating a quantum-accurate phase diagram that is true to life is an intractable problem for even a single elemental combination. Using a phase-space sampling method such as nested sampling can investigate a single pressure-composition point using 100 million samples of configuration space. This would amount to 100 million quantum mechanical calculations, each of which may take 3-7 days to complete.

Machine learned interatomic potentials can be trained that approximate the quantum mechanics sufficiently to enable phase diagram calculations to be performed in a few days for each pressure-composition point.

Thus, to investigate the material properties for a single elemental composition requires the following:
1. quantum mechanical calculations for a representative set of materials at a fixed composition to form training data for a machine-learned potential and validation data to prove it;
2. creation of a machine-learned potential;
3. phase diagram calculation using the machine-learned potential and nested-sampling;
4. property calculation for stable phases using quantum mechanical calculations; and
5. statistical property calculation using molecular dynamics for each stable phase.

Scientific codes are available to perform each of these steps independently. Thus, three main resources are lacking in the current technology:
1. a method to automatically calculate the “representative set of materials” to train a machine-learned potential;
2. a method to combine the various scientific codes together to produce a fully-automated approach to material property prediction (and therefore discovery of new materials with exceptional properties); and
3. the computational power to execute the automated steps in the above methods.

### BRIEF SUMMARY OF THE INVENTION

We disclose a method for identifying novel materials using mass computational resources. In some embodiments, the novel materials are novel alloys. The method includes the step of placing a plurality of groups of elements in a queue. The groups of elements may be included in a series of computations according to their place in the queue. The queue may be created by ranking the groups of elements. This ranking may be performed by one or more options on the following list: one or more humans, a genetic algorithm, a machine learning algorithm in descriptor space, and an enumeration of all possibilities. In some embodiments, groups or individuals may pay to have a selected group of elements placed earlier in the queue.

The method includes using compute resources owned by a plurality of people and entities to perform the computations. In an example, the compute resources may include smart phones, laptop computers, desktop computers, tablet computers, and industrial computers.

A contract may be created which each owner may enter. The owner may agree to permit the user of the owner's compute resource to perform the calculations. In exchange, the owner may be paid in an agreed upon amount of a digital currency. The amount of digital currency may be dependent on the memory size and storage size of the compute resource, and the number of hours the owner has committed to be used for the computations. In some embodiments, the digital currency may be managed through a blockchain ledger.

The method includes the step of performing perform computations using a series of algorithms which create compute results. The compute results may include a phase diagram for each novel material. The series of algorithms may compile a database comprising the plurality of alloys for training machine-learned potentials, perform quantum mechanics calculations for each of the plurality of alloys in the database, fit machine-learned potentials, run nested sampling for phase diagram generation, run molecular dynamics simulations to extract statistical properties, and run quantum mechanics calculations to extract quantum-sensitive properties.

The method may include the step of verifying the computations which created the phase diagram using proof-of-work algorithms for each of the various calculation types listed above to ensure that users of the application are not forging results.

The method may include selecting one or more new material for synthesis and then synthesizing one or more of the new materials. The new materials may be commercialized, and the profits derived may be invested into performing method to discover more new materials.

The compute results including the phase diagram and the contracts may be stored on a main server in an encrypted state. The main server may be the only server on which algorithms capable of decrypting the compute results are stored. The compute results may be divided into a plurality of parts. Each part may be stored on one of a plurality of servers which may be managed by a plurality of service providers. Each service provider may be under the control of a different national government.

The compute results may be stored in two files. Each of the two files may store either an interim result or a full result. The full result may include all of the properties of the novel material while the interim result may include a subset of the full result. An algorithm may screen the interim result for a defined list of properties. The full result may be analyzed only if the material comprises the defined list of properties.

### BRIEF DESCRIPTION OF THE DRAWING

In order that the advantages of the invention will be readily understood, a more particular description of the invention briefly described above will be rendered by reference to a specific embodiment illustrated in the appended drawing. Understanding that this drawing depicts only a typical embodiment of the invention and is not therefore to be considered limiting of its scope, the invention will be described and explained with additional specificity and detail through use of the accompanying drawing.

FIG. 1 illustrates a flow chart providing steps which may be performed to discover materials according to the disclosed method.

### DETAILED DESCRIPTION OF THE INVENTION

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “organizing entity” means a corporate entity or any single individual or group of individuals who direct the use of the method disclosed herein.

While this invention is susceptible of embodiment in many different forms, there are shown in the drawing, which will herein be described in detail, a specific embodiment with the understanding that the present disclosure is to be considered as an exemplification of the principals of the invention and is not intended to limit the invention to the illustrated embodiment.

Worldwide, humanity possesses billions of processors in desktops, laptops, smartphones, smart TVs, cars, fridges, etc. For a sizable portion of each day, these processors are unused even though they have access to a main power supply. Because the devices are distributed through homes, government buildings, and businesses worldwide, they are collectively a distributed supercomputer running on commodity hardware.

We have developed algorithms to automatically:
1. produce databases of materials for training machine-learned potentials;
2. perform quantum mechanics calculations for every material in the databases;
3. fit machine-learned potentials;
4. run nested sampling for phase diagram generation;
5. run molecular dynamics simulations to extract statistical properties; and
6. run quantum mechanics calculations to extract quantum-sensitive properties.

In particular, we divide these algorithms into individual computation tasks that may be completed on commodity hardware and employ an automated queue to manage and schedule packages of related computations so they may easily be distributed to consumer devices worldwide. This may allow the calculations to be distributed across billions of devices so that properties for millions of materials may be calculated in a reasonable (and much shorter) amount of time.

The organizing entity may make payouts to participants using a digital currency, to incentivize participation in the distributed computation of materials discovery calculations. In some embodiments, the digital currency may be managed through a blockchain ledger. A payout amount may be assigned to each contract based on an algorithm that estimates the energy cost of performing the calculation on a standard device. This ensures an equitable payment that can be applied to both supercomputers and smaller devices, including, but not limited to consumer laptops, smart phones, computerized appliances, and tablets. Industrial computers which are more powerful than typical consumer devices, may also be used in the disclosed method. The payout value may have a near equivalent cash value in a defined national currency, for example, United States dollars, to the cost of power consumed to run the contract. This may ensure that the individual running the contract is compensated for the energy their device uses to complete the contract.

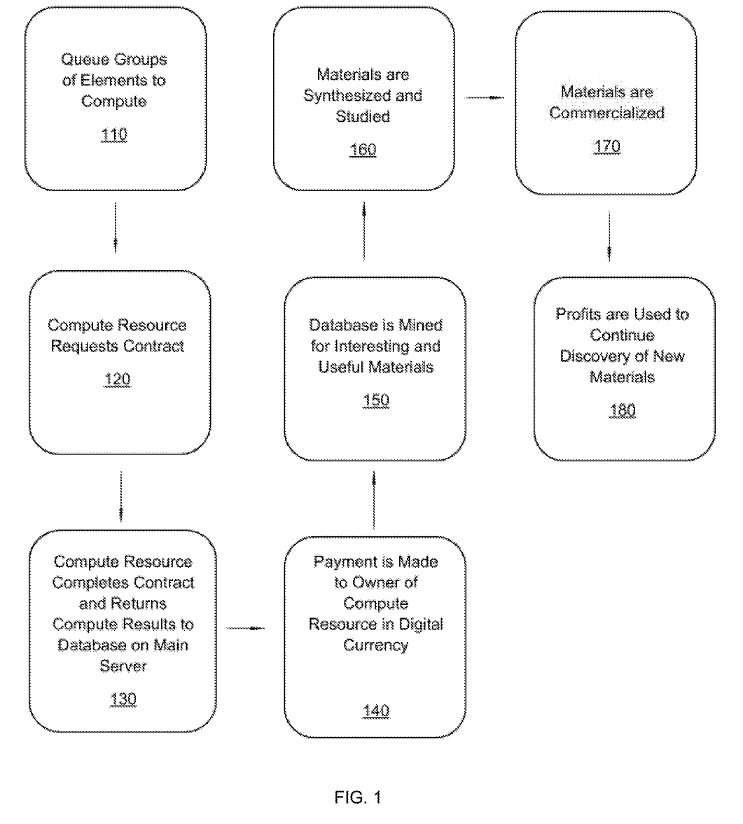

The process depicted in FIG. 1 begins with algorithms that list materials to be computed and the rank in which they are to be computed (step 110). Materials may be suggested by human experts, genetic algorithms, machine learning algorithms in descriptor space, or an enumeration of all possibilities. In an example, materials suggested by human experts may be prioritized in the automated search (given a higher rank in the queue), if the human experts are given and accept the option to pay more to have results computed faster. In an example, the human experts may include academic researchers or corporate entities with an interest in developing and using alloys which possess specific properties.

Users may register themselves and their compute device(s) through an application provided by the organizing entity which they may download to their compute device. They may be given the option to set a schedule, for example, a daily or weekly schedule, for computing. Alternatively, users may choose to “start computing now”. On consent, the user's compute device may request a compute contract that is a function of the compute device's memory, storage, and compute resources, as well as the number of hours that the user has committed to the computation (step 120). Note that all compute devices with enough compute power and memory to perform materials discovery calculations may be supported by the disclosed method.

Once the computation is completed, the compute results may be encrypted and sent back to a main server (step 130). The user may then be provided with a payout in the digital currency (step 140). The transaction may be stored in a blockchain ledger. Users may be able to see their account balances and its current market value through the application. Compute results may be made up of two separate files: the full results and the interim results. Each interim result may be a small piece of the compute result that contains only a few main properties but not the full protocol for making the material. The interim result works as a trigger to identify if there is merit in reviewing the full result set and investigating the material further. An algorithm may screen the interim results in the database to determine which alloys possess a defined set of properties and, therefore, warrant further evaluation of the full results.

The main server receiving the compute results may divide all results between a plurality of servers under the control of a plurality of service providers. The plurality of servers may be located in and under the control of different nations so that no single server, nation, or other entity has access to the full result set. Data may be stored and transported in an encrypted state. Only the organizing entity's main server may be able to decrypt the data in order to mine all computed properties to identify those materials with exceptional properties or those with particularly desired properties. The database may be mined and new materials with desirable properties may be discovered (step 150). In some embodiments, the materials may be synthesized to verify their properties. In some embodiments, the results of the compute contract may be verified using proof-of-work algorithms for each of the various calculation types listed above to ensure that users of the application are not forging results in an effort to receive payouts.

The newly discovered materials may drive the creation of new technologies. The new materials may be synthesized and studied (step 160). Patent protection claiming the new materials and/or the new technologies may be obtained in relevant jurisdictions. These technologies may be licensed to entities which may engineer the materials into usable products (step 170). At every stage in the development and licensing process, any profits that the organizing entity realizes as a result of mined materials may be reinvested to produce more new materials using the disclosed method (step 180). This process may create a supporting demand for the virtual currency in use.

Corporations, academic groups, or others may pay for the opportunity to request that the disclosed method to be used to perform computations which may identify materials which possess desired properties. In this situation, the requested calculation may be ranked higher in the queue. Such requests may be paid for in the digital currency, which helps contribute to fungibility of the digital currency.

Compute contracts and compute results may be compressed using custom or general compression algorithms. Code may be distributed to devices using a container service, for example, Docker, or compiled natively for maximum performance.

Corporate offices contain vast amounts of computing power that sits idle outside of regular business hours. Corporations may be given the opportunity to set up corporate accounts where employee desktops and laptops will complete compute contracts during non-office hours. Such corporations may also possess industrial computers which are not used during off-hours and which may be used according to the disclosed method.

While specific embodiments have been illustrated and described above, it is to be understood that the disclosure provided is not limited to the precise configuration, steps, and components disclosed. Various modifications, changes, and variations apparent to those of skill in the art may be made in the arrangement, operation, and details of the methods and systems disclosed, with the aid of the present disclosure.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art that changes may be made to the details of the above-described embodiments without departing from the underlying principles of the disclosure herein.

We claim:

1. A method for identifying novel alloys using mass computational resources comprising the following steps:
a. queue a plurality of groups of elements to include in a series of computations;
b. draft a plurality of contracts, each contract agreeing to a use of an associated compute resource within a plurality of compute resources in exchange for a payment made with a digital currency;
c. enter into the plurality of contracts with each of a plurality of owners of the plurality of compute resources agreeing to the use of the plurality of compute resources in exchange for an agreed upon amount of the digital currency;
d. perform computations which create compute results, the compute results comprising a phase diagram for each of plurality of alloys using a series of algorithms, wherein each of the plurality of alloys comprises the plurality of elements; and
e. pay the agreed upon amount of the digital currency to each of the plurality of owners of the plurality of compute resources.

2. The method of claim 1, further comprising the step of selecting one or more of the plurality of alloys for synthesis.

3. The method of claim 2, further comprising the step of synthesizing at least one of the one or more of the plurality of alloys.

4. The method of claim 1, wherein the plurality of compute resources comprises a consumer product comprising a computer.

5. The method of claim 1, wherein the plurality of compute resources comprises a smart phone, a laptop computer, a desktop computer, a tablet computer, and an industrial computer.

6. The method of claim 1, further comprising the step of commercializing at least one of the plurality of alloys.

7. The method of claim 6, further comprising the step of investing profits derived by commercializing the at least one of the plurality of alloys towards the development of a new material composition.

8. The method of claim 1, wherein each algorithm within the series of algorithms is configured to perform at least one of the following steps:
a. compile a database comprising the plurality of alloys for training machine-learned potentials;
b. perform quantum mechanics calculations for each of the plurality of alloys in the database;
c. fit machine-learned potentials;
d. run nested sampling for phase diagram generation;
e. run molecular dynamics simulations to extract statistical properties; and
f. run quantum mechanics calculations to extract quantum-sensitive properties.

9. The method of claim 1, wherein the digital currency is managed through a blockchain ledger.

10. The method of claim 1, wherein the compute results, the phase diagram, and the contract are stored in an encrypted state on a main server.

11. The method of claim 1, wherein the main server is the only server on which the algorithms capable of decrypting the compute results.

12. The method of claim 10, further comprising the step of dividing the compute results into a plurality of parts, wherein each of the plurality of parts is stored on one of a plurality of servers managed by a plurality of service providers.

13. The method of claim 11, wherein each of the plurality of servers is under the control of a different national government.

14. The method of claim 10, further comprising the step of storing the compute results in two files, each of the two files comprising either an interim result or a full result, wherein the full result comprises the complete properties of the alloys, and wherein the interim result comprises a subset of the full result.

15. The method of claim 13, further comprising the steps of applying an algorithm which screens the interim result for a defined list of properties, and analyzes the full result if the interim result indicates that the alloy comprises the defined list of properties.

16. The method of claim 1, further comprising the step of verifying the computations which created the phase diagram using a proof-of-work algorithm.

17. The method of claim 1, wherein each of the plurality of contracts is a function of the following:
a. a memory size of the associated compute resource;
b. a storage capability of the associated compute resource; and
c. a number of hours of committed compute time using the associated compute resource.

18. The method of claim 1, further comprising the step of ranking the order in which each of the plurality of groups of elements are placed in a queue.

19. The method of claim 18, wherein the step of ranking is performed by at least one item selected from following list:
a. at least one human;
b. a genetic algorithm;
c. a machine learning algorithm in descriptor space; and
d. an enumeration of all possibilities.

20. The method of claim 19, further comprising the step of ranking a requested group of elements higher in the queue in exchange for an amount of the digital currency.
